(19) United States
(12) Patent Application Publication
(10) Pub. No.: US 2024/0214313 A1
(43) Pub. Date: Jun. 27, 2024

(54) ENERGY EFFICIENT DATA TRANSMISSION

(71) Applicant: Cisco Technology, Inc., San Jose, CA (US)

(72) Inventors: Eric A Voit, San Jose, CA (US); Santosh Kumar Upadhyaya, San Jose, CA (US); Sarat C Pollakattu, San Jose, CA (US); Valiveti Vamsi Krishna, San Jose, CA (US)

(21) Appl. No.: 18/069,703

(22) Filed: Dec. 21, 2022

(51) Int. Cl. H04L 47/127; H04L 47/34

(52) U.S. Cl. CPC H04L 47/127; H04L 47/34

(57) ABSTRACT

Embodiments of the present disclosure provide energy efficient data transmission operations which may be configured to selectively energize some of a plurality of links within a given data transmission channel based at least in part on a detected amount of traffic or a predicted amount of traffic while ensuring that data is delivered in an orderly and energy-efficient manner.

### TECHNICAL FIELD

The present disclosure relates to power saving optimizations in networking and in particular, methods for managing traffic in a data transmission channel (e.g., EtherChannel).

### BACKGROUND

A data transmission channel may be associated with a port link aggregation technology or port-channel architecture that facilitates grouping a plurality of physical links or ports (e.g., Ethernet links) to create a single logical link for the purpose of providing fault-tolerance and high-speed links between switches, routers, and/or servers.

A physical port may be a connection point for network cables and network infrastructure devices that can be used to transmit data packets between network devices. Logical groupings of multiple physical ports may be aggregated into a single logical port in order to increase the bandwidth of a data transmission channel. One example of such port aggregation implementation is Cisco Technology, Inc.'s Fast EtherChannel™ port group in a Fast Ethernet network. In such data transmission channels (e.g., EtherChannel or port channel), load sharing may be statically configured where each port is assigned a source address, a destination address or both, in such a manner that all the physical ports in the port group are used.

EtherChannels typically use a hash algorithm to reduce part of the binary pattern of addresses in a frame of data to a numerical value called a Result Bundle Hash, and that hash value is used to assign the data frame to one of the physical links in the channel to distribute frames across the links. Accordingly, using the same addresses and session information should hash to the same port in the channel. This method prevents out-of-order packet delivery. When a hash algorithm computes a value, that value is used to determine a particular port of egress in the EtherChannel. The port setup includes a mask that indicates how many hash values and which hash values a particular port accepts for transmission to a partner device. These systems are plagued by technical challenges and limitations. For example, power may be consumed for functioning of all physical ports, even when data packets are not passing through them. Furthermore, the prior systems have had no mechanism by which ports could adjust which hash values or how many hash values could be accepted on a given link by analyzing a global view of a network bundle of links. In prior systems, links had to managed independently of one another, which often meant that all of the links had to be maintained in a powered-on state even if they were in standby mode.

### BRIEF SUMMARY OF THE DISCLOSURE

In accordance with various embodiments of the present disclosure, a method is provided. The method may comprise: monitoring traffic in a data transmission channel comprising a plurality of physical links; detecting a traffic change associated with at least one physical link in the data transmission channel; based at least in part on the traffic change, determining whether or not to energize or de-energize at least one of the plurality of physical links; and based at least in part on the determination and using at least one of an energize algorithm and a de-energize algorithm, redirecting a traffic flow between the plurality of physical links while retaining a sequential ordering of data frames between a plurality of network devices.

In accordance with another embodiment of the present disclosure, an apparatus for controlling traffic in a data transmission channel comprising a plurality of physical links is provided. The apparatus may comprise: a processor; and a machine-readable medium including instructions executable by the processor comprising: one or more instructions for monitoring traffic in the data transmission channel; one or more instructions for detecting a traffic change associated with at least one physical link in the data transmission channel; one or more instructions for, based at least in part on the traffic change, determining whether or not to energize or de-energize at least one of the plurality of physical links; and one or more instructions for, based at least in part on the determination and using at least one of an energize algorithm and a de-energize algorithm, redirecting a traffic flow between the plurality of physical links while retaining a sequential ordering of data frames between a plurality of network devices.

In accordance with another embodiment of the present disclosure, a system for controlling traffic in a data transmission channel comprising a plurality of physical links, the system comprising: a network interface in the data transmission channel configured to receive a data stream; a processor configured to: monitor the data stream in the data transmission channel; detect a traffic change associated with at least one physical link in the data transmission channel; based at least in part on the traffic change, determine whether or not to energize or de-energize at least one of the plurality of physical links; and based at least in part on the determination and using at least one of an energize algorithm and a de-energize algorithm, redirect a traffic flow between the plurality of physical links while retaining a sequential ordering of data frames between a plurality of network devices.

In accordance with yet another embodiment of the present disclosure, a computer readable medium comprising instructions which, when executed by a processor, perform a method for controlling traffic in a data transmission channel comprising a plurality of physical links, the method comprising: monitoring traffic in the data transmission; detecting a traffic change associated with at least one physical link in the data transmission channel; based at least in part on the traffic change, determining whether or not to energize or de-energize at least one of the plurality of physical links; and based at least in part on the determination and using at least one of an energize algorithm and a de-energize algorithm, redirecting a traffic flow between the plurality of physical links while retaining a sequential ordering of data frames between a plurality of network devices.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

This summary is provided to introduce a selection of concepts in a simplified form that is further described below in the detailed description. This summary is not intended to identify key features or essential features of the claimed subject matter, nor is it intended to be used to limit the scope of the claimed subject matter.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1A illustrates an example environment, wherein embodiments of the present disclosure can be practiced.

FIG. 1B illustrates another example environment in accordance with certain embodiments of the present disclosure.

FIG. 2 is a flow diagram of an example method in accordance with certain embodiments of the present disclosure.

FIG. 3 is a schematic diagram in accordance with certain embodiments of the present disclosure.

FIG. 4 is a schematic diagram in accordance with certain embodiments of the present disclosure.

FIG. 5 is a flow diagram of an example method in accordance with certain embodiments of the present disclosure.

FIGS. 6A-B are flow diagrams of example methods in accordance with certain embodiments of the present disclosure. FIG. 6A is based on a link de-energizing trigger from a partner network device, and FIG. 6B is based on a link de-energizing trigger calculated at an actor network device.

FIG. 7 is a schematic diagram in accordance with certain embodiments of the present disclosure.

FIGS. 8A-D are schematic diagrams in accordance with certain embodiments of the present disclosure. FIG. 8A illustrates links of assigned priorities between an actor network device and a partner network device. FIG. 8B is a matrix illustrating a series of network links identified by respective result bundle hashes and assigned priorities according to this disclosure. FIG. 8C is one implementation of an algorithm to energize and/or de-energize network links according to an algorithm disclosed herein by adjusting priorities of the links. FIG. 8D is another implementation of an algorithm to energize and/or de-energize network links according to an algorithm disclosed herein by adjusting the number of links that are energized within a network bundle.

FIG. 9 is a schematic diagram of pseudocode for a link energizing algorithm in accordance with certain embodiments of the present disclosure.

FIG. 10 illustrates a computer environment in which network devices described herein have appropriate hardware to perform operations in accordance with certain embodiments of the present disclosure.

### DESCRIPTION OF EXAMPLE EMBODIMENTS

### Overview

The terms data transmission channel or EtherChannel may refer to a data channel using a port link aggregation technology or port-channel architecture that facilitates grouping a plurality of physical links (e.g., Ethernet links) to create a single logical link for the purpose of providing fault-tolerance and high-speed links between switches, routers, and/or servers.

Existing systems may be configured to manage incoming traffic based on a total current bandwidth. For example, existing systems may be configured to direct traffic within a network based on a tunable set of parameters such as a source Internet Protocol (IP) address or destination IP address. In the above example, any traffic going between a given source IP address and destination IP address may use the same physical link to ensure that packets are delivered in an orderly fashion. Thus, power saving techniques in these systems are suboptimal as they are configured to adhere to preset rules while distributing traffic, which in turn hinders power saving efforts. By way of example, certain data packets may be associated with a particular Internet Protocol (IP) address such that they can only be transmitted via a particular link within a data transmission channel. Accordingly, if incoming data packets associated with the given IP address exceed a given threshold for the link, energizing additional links may not improve or speed up data transmission processes because the incoming data packets can only be transmitted via the designated link. Therefore, in such examples, merely increasing overall network bandwidth is insufficient for improving data transmission speed and efficiency within the network.

Embodiments of the present disclosure provide energy efficient (e.g., green) data transmission channel operations which are configured to selectively energize some of a plurality of links within a given data transmission channel (e.g., EtherChannel) based at least in part on a detected amount of traffic or a predicted amount of traffic while ensuring that data (e.g., frames, packets) are delivered in an orderly fashion. For example, embodiments of the present disclosure ensure proper ordering of traffic between at least two network devices or hosts by energizing and de-energizing particular ports using an energize algorithm or a de-energize algorithm. This disclosure further covers systems, methods, and apparatuses that calculate an amount of bandwidth that needs to be added to a bundle of links or can be removed from a bundle of links, depending on peaks and troughs of network transmission demand.

### Example Network

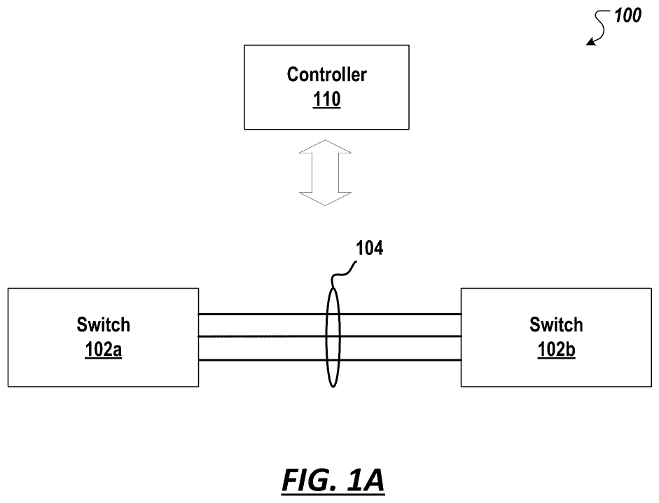

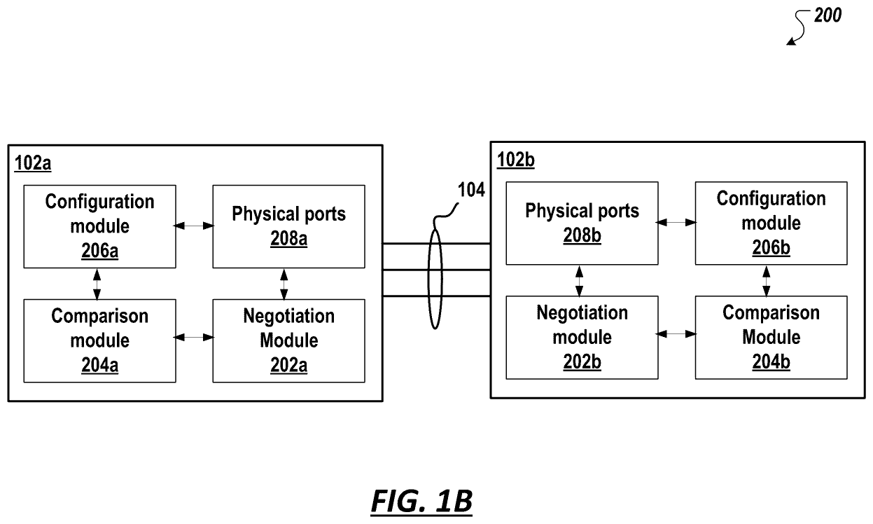

Referring now to the drawings, FIG. 1A illustrates an environment 100, wherein the embodiments of the present disclosure can be practiced. Environment 100 includes network devices switch 102a and switch 102b, and data transmission channel 104 (e.g., EtherChannel), and a controller 110. The controller 110 may be in electronic communication with the network devices (e.g., switch 102a and switch 102b). For example, the controller 110 may be configured to monitor traffic in the data transmission channel 104 (e.g., EtherChannel). In some embodiments, the controller 110 may operate to trigger various actions to be performed by one or more network devices (e.g., switch 102a and switch 102b).

Embodiments of the present disclosure include operations that produce a bandwidth change on a network to match transmission demands by energizing and de-energizing physical links included within a logical link bundle. The computer implemented steps necessary to implement such bandwidth changes may be performed by individual network devices that have computer processors, computer memory, and computer implemented software integrated within the network device to complete the methods and implement the systems of this disclosure. In other embodiments, an overarching network controller, having appropriate computerized hardware (e.g., control processors, control memory, and control software) may have access to more than one network device to trigger certain implementations described herein.

As used herein, a network device encompasses, but is not limited to, a router, a switch, a hub, a server, or any hardware that directs data packets (e.g., traffic) from one point on a network to another. In various non-limiting embodiments, such as shown in FIG. 1A, a switch 102a is a device that is capable of inspecting data packets as they are received, determining the source and destination device of the data packet, and appropriately forwarding the data packet. The source and destination device can be determined by using the Media Access Control (MAC) address, Internet Protocol (IP) address and so forth. In general, devices, communication links, protocols, data definitions and other characteristics can vary from those illustrated herein. Switch 102b, hereinafter referred to as link partner 102b, is a device with similar functionalities and form as switch 102a. Data transmission channel 104 (e.g., EtherChannel) links switch 102a to link partner 102b. Data transmission channel 104 (e.g., EtherChannel) is a transmission channel that enables bandwidth aggregation by grouping multiple Ethernet links with the same or differing speeds of data transmission into a single logical channel. Examples of data transmission channel 104 (e.g., EtherChannel) include Fast EtherChannel (FEC), Gigabit EtherChannel (GEC) and the like. Each Ethernet link is connected to a physical port at switch 102a to a physical port at link partner 102b. The physical ports that participate in the transmission of data packets are known as active physical ports and are grouped together as a logical port. The physical ports that remain powered down during the transmission of data packets at switch 102a are known as inactive and de-energized physical ports. In some embodiments of the present disclosure, data transmission channel 104 (e.g., EtherChannel) includes any number of Ethernet links.

FIG. 1B is a block diagram of another example environment 200 in accordance with certain embodiments of the present disclosure. The example environment 200 includes switch 102a, link partner 102b and data transmission channel 104 (e.g., EtherChannel). Switch 102a includes negotiation module 202a, comparison module 204a, configuration module 206a, and one or more of physical ports 208a. Link partner 102b includes negotiation module 202b, comparison module 204b, configuration module 206b, and physical ports 208b. Data transmission channel 104 (e.g., EtherChannel) connects physical port 208a to physical port 208b. Negotiation module 202a negotiates the parameters for allocation of physical port 208a to the logical channel with link partner 102b. The parameters include a re-energization threshold, a de-energization threshold and a protocol for selecting one or more physical ports from physical port 208a at switch 102a. In various embodiments of the present disclosure, event-based parameters can be used that can help determine how a port is allocated. For example, the event-based parameters can be related to port failure, addition of a new network device, and the like. In some embodiments of the present disclosure, parameters can be specified as default values so that not all of the parameters need be negotiated every time. For example, re-energization and de-energization thresholds can be predetermined for specific ranges or types of ports.

Negotiation module 202a receives one or more data packets from link partner 102b containing the values for the parameters. The values for the parameters are also calculated at negotiation module 202a. The values for the parameters received from link partner 102b and the values for the parameters calculated at negotiation module 202a are compared and then the final values of the parameters are decided. Thereafter, the final values of the parameters are sent to comparison module 204a. The final values include value for re-energization threshold, value for de-energization threshold and a sequence for selecting one or more physical ports from physical port 208a at switch 102a. Comparison module 204a compares values (e.g., bandwidth load) at physical port 208a with the value of re-energization threshold and the value of de-energization threshold. The comparison facilitates in determining the configuration that is capable of handling the bandwidth load with minimum power requirement. Configuration module 206a configures physical ports 208a based on the comparison. The comparison can be a simple numerical comparison to determine whether a value representing the bandwidth load is higher or lower or equal to a value of a threshold. Other types of comparisons can be made including determining whether the values are within a specified range or relationship to each other. More complex comparisons can also be used such as varying comparison criteria over time or based on load conditions.

### Exemplary Operations

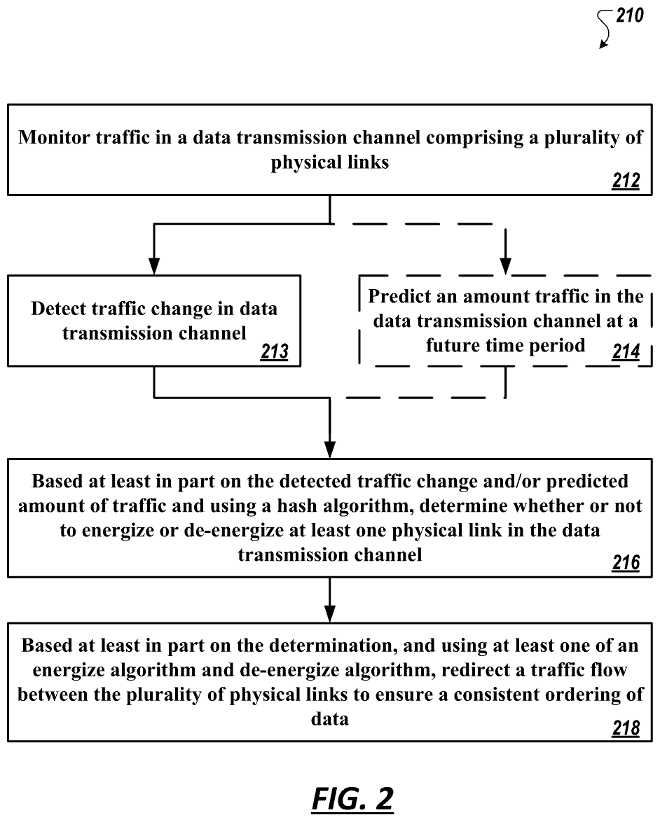

Referring now to FIG. 2, an example method 210 for dynamically controlling traffic in a data transmission channel (e.g., EtherChannel) is provided herein. In some embodiments, the data transmission channel may be similar, identical to, and/or otherwise embodied as the environment 100 described in relation to FIG. 1A and the system 200 described in relation to FIG. 2. In some embodiments, the method 210 may be at least partially implemented or performed by and/or in conjunction with a separate or remote device or controller, such as the controller 110 described above in connection with FIG. 1A.

Beginning at step/operation 212, the method 210 includes monitoring by the at least one network device or controller, traffic in a data transmission channel. As noted herein, the data transmission channel may be or comprise an EtherChannel.

Subsequent to step/operation 212, the method 210 proceeds to step/operation 213. At step/operation 213, the method 210 comprises detecting, by the at least one network device or controller, a traffic change (e.g., increase or decrease) in a data stream of the data transmission channel that is associated with at least one physical link.

Additionally, and/or alternatively, in some embodiments, at step/operation 214, the method 210 further comprises predicting, by the at least one network device or controller, an amount of traffic in the data transmission channel at a future time period (e.g., an expected amount of traffic during a future time period).

Subsequent to step/operation 213 and/or step/operation 214, the method 210 proceeds to step/operation 216. At step/operation 216, the method comprises, based at least in part on the predicted amount of traffic and using a hash algorithm, determining, by at least one network device or controller, whether or not to energize or de-energize at least one physical link in the data transmission channel. In some embodiments, step/operation 216 comprises determining, by the at least one network device or controller, whether or not to energize or de-energize at least one physical link based at least in part on at least one determined port priority.

The term port priority may refer to a factor or consideration that determines whether a given port can be elected as a root port of a device. Said differently, the port with the highest priority may be elected as a root port. In various embodiments, port priority may influence how data is propagated along different physical paths in a data transmission channel. In some embodiments, port priority may be a configurable parameter that is associated with a particular device port and/or may be negotiated between devices (e.g., two switches). In some embodiments, step/operation 216 comprises using a hash algorithm to determine whether energizing or de-energizing at least one physical link will result in an improvement to data transmission speed and/or efficiency within the network (e.g., by determining an expected fill of each of the plurality of physical or member links). By way of example, when traffic is increasing beyond a threshold on a physical link, it might not be necessary to add a new physical link. Embodiments of the present disclosure may locally analyze the traffic in a particular physical link and define a larger hash which splits the current traffic mix. Accordingly, at least a portion of the traffic can be sent to a newly activated link or to a lightly loaded existing link. Such specific mechanism for dynamically rebalancing hashing algorithms within a flexible domain of data transmission channel (e.g., EtherChannel) physical links are discussed in more detail herein. In some embodiments, Consistent Hashing with Bounded Loads may be utilized for dynamic rebalancing operations. In some embodiments, dynamic management of data transmission channel (e.g., EtherChannel) hashing algorithms may be performed on a host or remote device.

Subsequent to step/operation 216, the method 210 proceeds to step/operation 218. At step/operation 218, the method 210 comprises, based at least in part on the determination and using at least one of an energize algorithm or de-energize algorithm, redirecting, by the at least one network device or controller, a traffic flow amongst the plurality of physical links to ensure a sequential or consistent ordering of data. In some implementation, step/operation 218 includes redirecting a traffic flow between the plurality of physical links while retaining a sequential ordering of data frames between network devices (e.g., hosts that are attached to either end of the data transmission channel). For example, the method 210 may include ensuring an efficient distribution of data other than bandwidth, such as queue depths of respective active links, in order to assure the correct ordering of packets using the lowest possible number of links or facilities. In some embodiments, step/operation 218 further comprises, subsequent to de-energizing at least one of the plurality of physical links, reducing energy consumption of at least one network device associated with (e.g., physically attached to) the at least one of the physical links. For example, step/operation 218 may comprise performing (e.g., generating a control indication to trigger) de-powering electrical signal serialization or de-serialization functions, de-powering an application-specific integrated circuit (ASIC) or hardware functionality, and/or de-powering a line card (e.g., that is no longer associated with an energized port) serving at least one physical link. In some embodiments, a controller may pre-emptively trigger energizing or de-energizing at least one of a plurality of physical links based on a predicted traffic spike or drop.

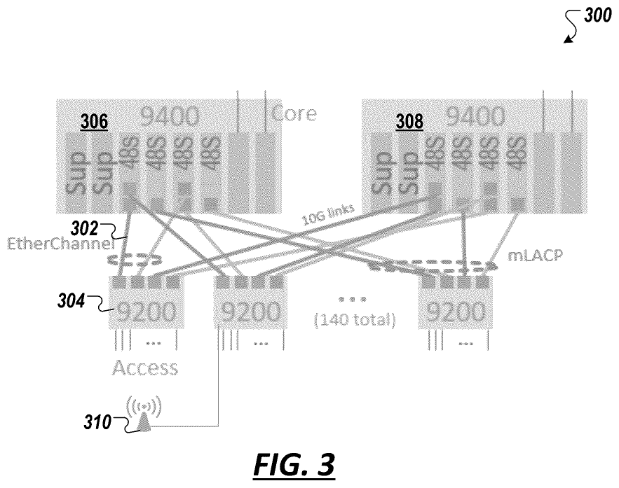

Referring now to FIG. 3, a schematic diagram in accordance with certain embodiments of the present disclosure is provided. In particular, FIG. 3 illustrates an example portion of a network 300 comprising at least one data transmission channel 302 (e.g., EtherChannel), a plurality of switches (at least a first switch 304, a second switch 306, and a third switch 308). In some embodiments, the network 300 may further comprise at least one wireless access point 310. In some embodiments, at least a portion of the network 300 may be in electronic communication with a controller (e.g., over a wireless network). The at least one data transmission channel 302 (e.g., EtherChannel) may comprise a 10 Gigabit (GB) Ethernet (RJ-45) port that is configured to support multiple data rates for speeds up to 10 GB per second over a cable (e.g., twisted copper cabling or fiber). As further depicted in FIG. 3, the network 300 may utilize a Link Aggregation Control Protocol (LACP) or Multichassis Link Aggregation Control Protocol (mLACP) in order to deliver system-level redundancy in the event of chassis failure and/or facilitate bundling of a plurality of physical ports together to form a single logical channel. In some embodiments, implementing the method 210 described above in connection with FIG. 2 may result in power savings greater than or between 0.8-1.5 W per port. In some examples, such implementations may further result in Heating, ventilation, and air conditioning (HVAC) savings between 0.4-0.7 W per port.

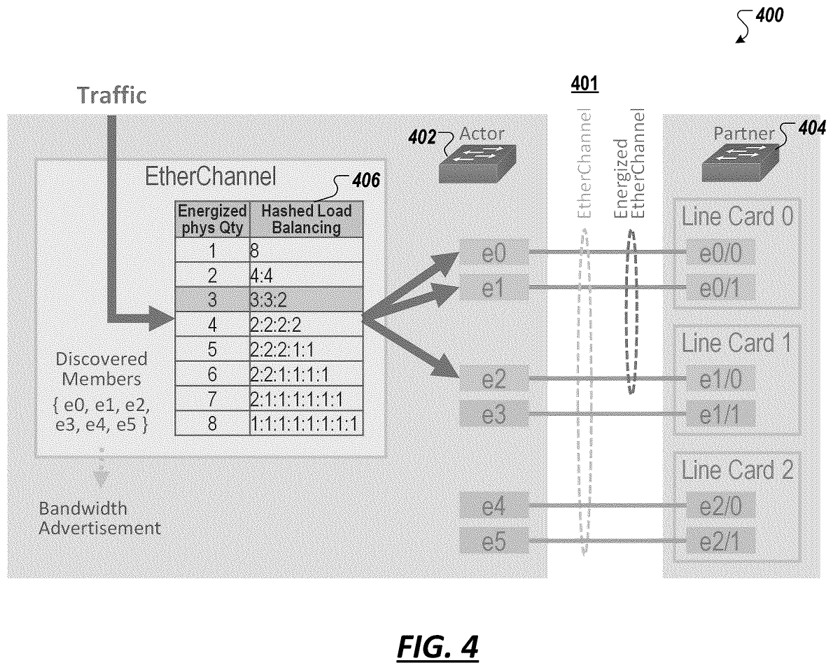

Referring now to FIG. 4, a schematic diagram in accordance with certain embodiments of the present disclosure is provided. In particular, FIG. 4 depicts at least a portion of a network 400 that can be used to implement a link management protocol. As shown, the network 400 comprises a first network device 402 (e.g., actor) and a second network device 404 (e.g., partner). In various embodiments, and as illustrated, the first network device 402 and the second network device 404 may be in electronic communication with one another via a data transmission channel 401 (e.g., EtherChannel). As described herein, the data transmission channel 401 comprises a single logical link defining a plurality of physical links/ports between the first network device 402 and the second network device 404. In some embodiments, all ports or physical links of the data transmission channel 401 may initially be active and discovered by Link Aggregation Control Protocol Data Units (LACPDU). As specified in the Institute of Electrical and Electronic Engineers (IEEE) 802.3ad, LACPDUs implement dynamic link aggregation and de-aggregation, allowing Link Aggregation Control Protocol (LACP)-enabled switches at both ends to exchange data/information. The first network device 402 and the second network device 404 may send and receive LACPDUs to one another. Additionally, each of the first network device 402 and the second network device 404 may compare LACP system priorities to determine which network device is the actor or partner. In the example depicted in FIG. 4, the first network device 402 has a higher LACP system priority than the second network device 404. Thus, the first network device 402 is designated as the actor network device while the second network device 404 is designated as the partner network device.

As further depicted in FIG. 4, an example table 406 depicting a hashing mechanism in accordance with embodiments of the present disclosure is provided. As shown a given data flow is hashed into eight possible hash results which are distributed to eight of fewer physical links depending on how many links are available. With reference to the table 406 depicted in FIG. 4, if there are five ports in the data transmission channel (e.g., EtherChannel), and the fourth or fifth links are over capacity, but the first through third are not, adding any additional links (six, seven, or eight) will not improve congestion. All that will happen is that the data flow will be switched between ports without any capacity benefits. Additionally, as flows are flushed and moved between facilities, undesirable disruptions may occur. Accordingly, embodiments of the present disclosure provide systems in which each physical link has its own threshold to request the same sequence of physical links be energized based on the number of viable ports in the data transmission channel (e.g., EtherChannel) at full capacity, and the number of ports that are currently energized. Accordingly, the number of physical links in a bundle can be used as an input to a hash algorithm, facilitating dynamic distribution of data over physical links. In some embodiments, certain types of flows may be directed to specific physical links/members of a data transmission channel (e.g., EtherChannel). This can be implemented to ensure that the longest lasting flows and the flows having the least loss/delay tolerance are aimed at the physical ports that are likely to stay energized even when the other ports are set to dark. In some examples, a flush mechanism within EtherChannel (e.g., LACP & Port Aggregation Protocol (PAgP) can be implemented to prevent looping Frames. Application layer impacts from such a flush through can be minimized by selecting which flow should go to physical links that are unlikely to need a flush.

All ports or links may initially be active and discovered (e.g., as shown, e0, e1, e2, e3, e4, and e5) and a bandwidth advertisement (e.g., a network status packet transmitted to any or all network devices) may include subsequently powered-down links which keep state changes from propagating via an interior gateway protocol (IGP). The IGP may be or comprise a routing protocol that is used to exchange routing information within a network. In some embodiments, at least one physical link of the data transmission channel 401 (e.g., EtherChannel) may be energized or de-energized based at least in part on the next highest port priority. Within the data transmission channel 401 (e.g., EtherChannel) a hash algorithm may be used to select at least one link to energize or de-energize based at least in part on a determined benefit to specific overtaxed links (e.g., by determining an expected fill of each of the plurality of physical or member links). Additionally, frame or packet reordering resulting from link addition or removal can be addressed using flush mechanisms (e.g., an EtherChannel flush mechanism that removes all data from a link and updates associated routing tables and the like) to ensure that a sequential ordering of data frames is retained. In some embodiments, an adaptive load distribution algorithm can be used such that existing flows hash to the same link even where bundle membership changes. In some implementations, all physical ports or links within the data transmission channel 401 (e.g., EtherChannel) may be subject to periodic wake ups in order to validate continued connectivity when certain ports are not energized for a threshold time period. In some embodiments, during the turn-down process of a lightly used physical link, the system may be configured to redirect existing flows to an alternate physical link when it is clear that a previous flow is undergoing a pause which effectively completes (flushes) network queued traffic flowing towards the destination. For example, a network device or controller may locally tune with a pre-emptive mechanism which understands where specific flows are going next, and gracefully redirect such flows to a new physical link. For example, in some non-limiting implementations, a five-tuple flow that has not been previously received for a LACP's process may be analyzed by a network device to determine identifiers such as source IP address, source port, destination IP address, destination port, and transport protocol. This ensures that flows are on a proper link within a bundle and are directed to the correct hash and priority.

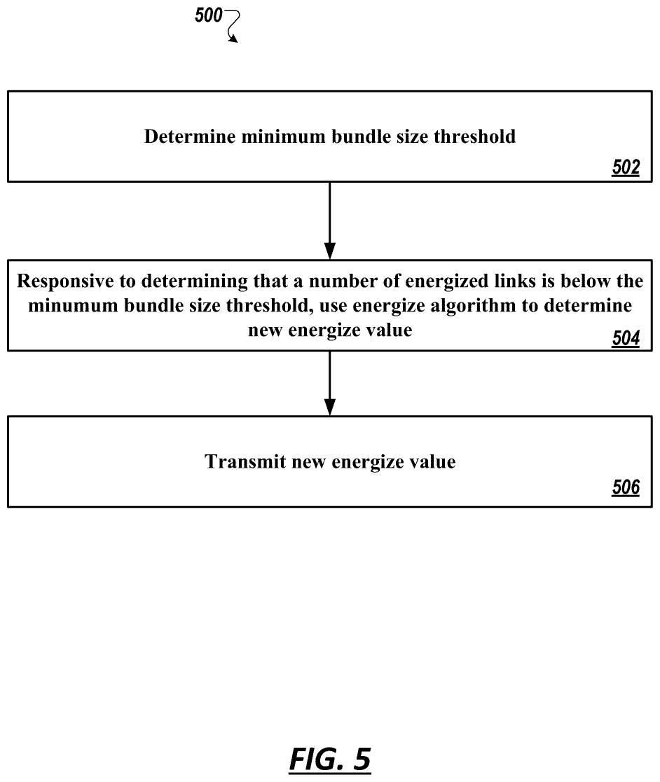

Referring now to FIG. 5, an example method 500 implementing an energize algorithm within a data transmission channel (e.g., EtherChannel) is provided herein. In some embodiments, the method 500 may be at least partially implemented using a controller, such as the controller 110 described above in connection with FIG. 1A.

Beginning at step/operation 502, the method 500 comprises determining, by a network device or controller, a minimum bundle size threshold with respect to a data transmission channel (e.g., EtherChannel). For example, within a predetermined time period of discovering a new data transmission channel (e.g., EtherChannel), an example controller may set a parameter, <energize>=EtherChannel bundle size, where <energize> indicates the number of physical links that should be powered on. In some examples, the controller may continually pass <energize> to peer(s) using a reserved LACPDU field only within the physical link associated with Actor port priority 0 LACPDU (i.e., the highest priority Actor port).

In some embodiments, a controller may operate in a deterministic fashion to predict network conditions that can be used to set a bundle size threshold (e.g., a minimum or maximum bundle size threshold). In some embodiments, the example controller may use event correlation sets for a window of time. For example, the controller may trigger energizing and/or de-energizing links based at least in part on historical data. In some embodiments, the controller may be configured to trigger energizing and/or de-energizing physical links (e.g., by generating and/or providing a control indication to at least one network device) based on a time of day (e.g., during work hours or activate a certain number of physical links at night). In some embodiments, the controller may be configured to trigger energizing and/or de-energizing links based on certain events, such as a detected number of active users or active hosts, building occupancy, number of Identity Service Engine (ISE) logons, number of new client Dynamic Host Configuration Protocol (DHCP) request events which may correlate with traffic spikes, traffic profiles provided by at least one router, and/or the like. In some embodiments, each of the above examples may be configurable parameters that are set by a system administrator.

In various examples, an external system (e.g., controller) may be configured to predict traffic spikes which will go to any particular member of a data transmission channel (e.g., EtherChannel) and pre-emptively increase the number of channels energized for the particular data transmission channel (e.g., EtherChannel). In some embodiments, the system is configured to recognize indicators that may potentially result in a bandwidth spike on the data transmission channel (e.g., EtherChannel) such as people arriving in a location (e.g., based on new radio connections being made to an Access Point). Upstream data transmission channels (e.g., EtherChannels) may be energized in anticipation of increased traffic, or certain types of Domain Name System (DNS) requests (e.g., lookup to YouTube® or Netflix® DNSs which may indicate that more traffic is imminent). In some embodiments, the system or controller is configured to administratively set/tune the optimal load balancing hash algorithms (per platform or per data transmission channel/EtherChannel) to minimize flows which might have to be flushed/moved as part of a growing/shrinking of physical bandwidth.

Subsequent to step/operation 502, the method 500 proceeds to step/operation 504. At step/operation 504, the method 500 comprises responsive to determining that a number of energized links is below the minimum bundle size threshold, using, by the network device or controller, an energize algorithm to determine a new energize value. By way of example, in an instance in which the number of energized EtherChannel links is less than an EtherChannel bundle size, the controller may use an energize algorithm to calculate a potentially higher value for <energize>.

Subsequent to step/operation 504, the method 500 proceeds to step/operation 506. At step/operation 506, the method 500 comprises, if the evaluation in the preceding step results in a higher value of <energize>, the at least one network device or controller transmits the new energize value, such as by sending a new LACPDU. For example, the controller may scan peer LACPDU port priority 0 for requests to turn on local ports. In some embodiments, such as where a network device receives the new energize value (e.g., higher value of <energize>), the network device may turn on local physical ports and/or await remote LACPDU message(s) indicating that end-to-end physical link(s) have become active. In some examples, the at least one network device or controller may add new member(s) to an energized EtherChannel. For instance, step/operation 506 may include reallocating or implementing hash changes so that impacted flows migrate to new physical link(s).

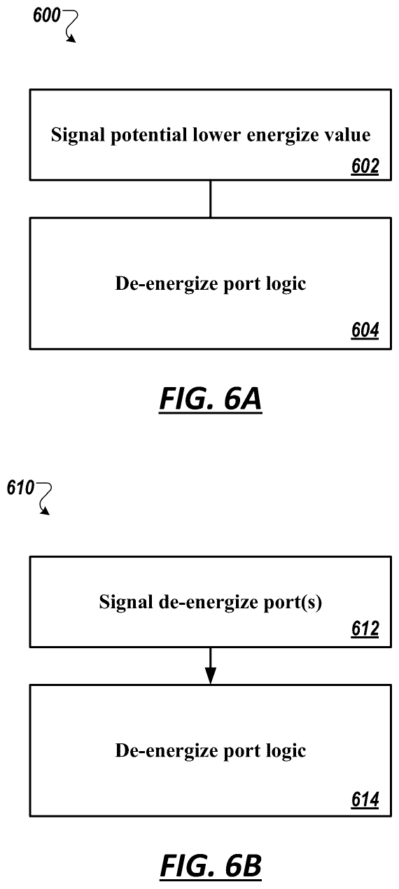

Referring now to FIG. 6A and FIG. 6B, example methods 600, 610 implementing a de-energize algorithm within a data transmission channel (e.g., EtherChannel) is provided herein. In the example depicted in FIG. 6A, the method 600 may be implemented by a partner network device, while the method 610 depicted in FIG. 6B may be implemented by an actor network device.

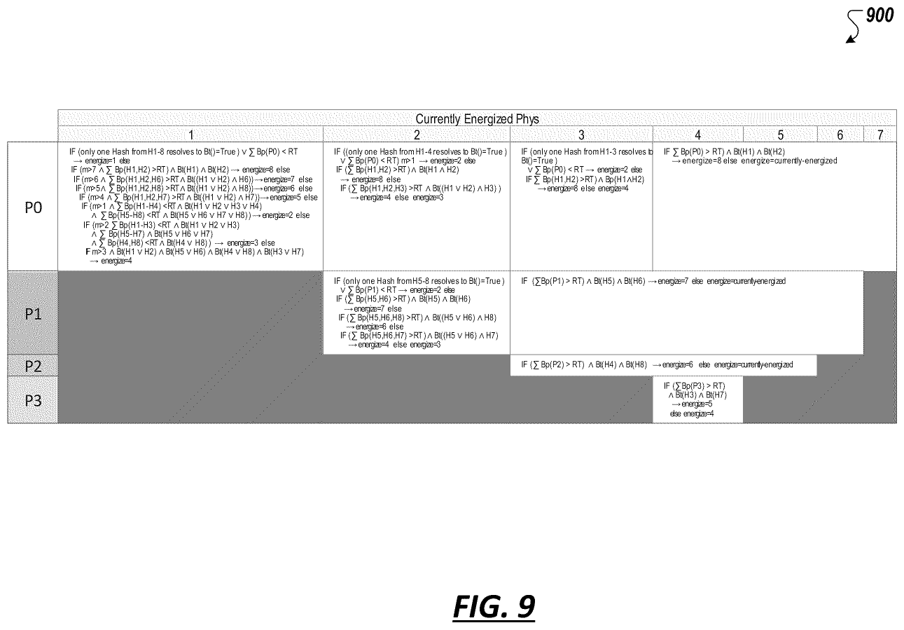

As depicted in FIG. 6A, beginning at step/operation 602, the method 600 comprises signaling, by a partner network device, a potentially lower energize value (e.g., lower value of <energize>). In some examples, the partner network device may run a de-energize algorithm periodically (e.g., every 10 minutes) and/or during predetermined time periods (e.g., during non-business hours. In some embodiments, the partner network device may include in the next LACPDU on Actor port priority 0 the new <energize>. Additionally, IF<energize> is increased, the partner network device may follow or initiate a “triggered Actor/Partner” logic as shown in FIG. 9.

In some embodiments, the example de-energize algorithm may include or require determining bandwidth queue fill per hash, percent queue fill per hash, or an expected fill for each of the plurality of physical links, which may be obtained (e.g., collected) by a counter on an egress port of a network device. In some embodiments, the de-energize algorithm may be run periodically during an evaluation interval having a time period that is significantly longer than an average flow duration. In some examples, the same algorithm can be used to re-energize links or ports.

### Example Implementation of De-Energize Algorithm

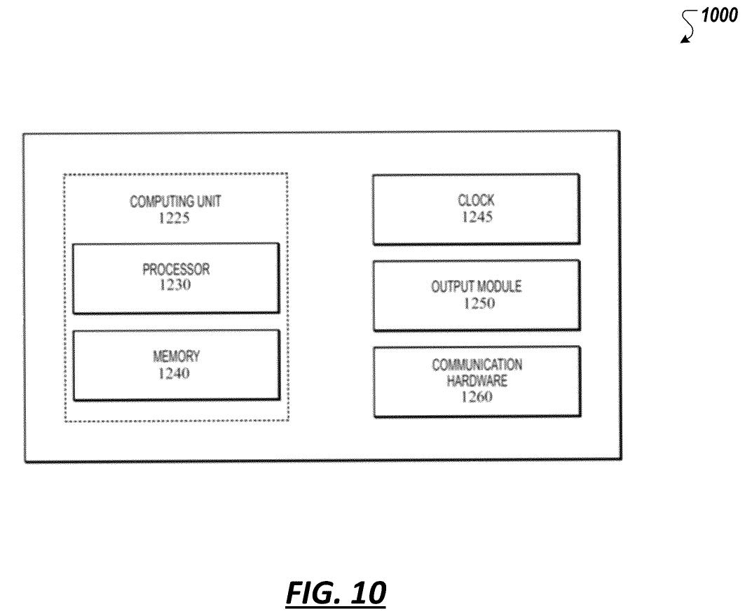

With reference to FIG. 6A and FIG. 6B, example computer program code implementing a de-energize algorithm is provided below. However, the scope of the present disclosure is not limited to the example provided below and various embodiments may comprise the use of various other methods. Example logic includes the following process that would be implemented by a computer, such as the computer shown in FIG. 10. The computer may be connected to or actually part of a network device as described.

```
            IF m=1 ∨ (only one Hash from H1-8 resolves to Bt( )=True ) ∨ Σ Bp(P0) < DT →
energize=1, else
    IF (m>7 ∧ Σ Bp(H1,H2) > DT ) ∧ Bt(H1) ∧ Bt(H2) → energize=8 else
    IF (m>6 ∧ Σ Bp(H1,H2,H6) > DT ∧ Bt((H1 ∨ H2) ∧ H6)) → energize=7 else
      IF (m>5 ∧ Σ Bp(H1,H2,H8) > DT ∧ Bt((H1 ∨ H2) ∧ H8)) → energize=6 else
      IF (m>4 ∧ Σ Bp(H1,H2,H7) > DT ∧ Bt((H1 ∨ H2) ∧ H7)) → energize=5 else
        IF (m>1 ∧ Σ Bp(H1-H4) < DT ∧ Bt(H1 ∨ H2 ∨ H3 ∨ H4) ∧ Σ Bp(H5-H8) < DT ∧
  Bt(H5 ∨ H6 ∨ H7 ∨ H8) ) → energize=2 else
        IF (m>2 ∧ (Σ Bp(H1-H3) < DT ∧ Bt(H1 ∨ H2 ∨ H3) ∧ Σ Bp(H5-H7) ∧ Bt(H5 ∨
  H6 ∨ H7) ∧ Σ Bp(H4,H8) < DT ∧ Bt(H4 ∨ H8) ) ) → energize=3 else
          IF m>3 ∧ Bt(H1 ∨ H2) ∧ Bt(H5 ∨ H6) ∧ Bt(H4 ∨ H8) ∧ Bt(H3 ∨ H7) →
  energize=4
  IF energize = min-links → energize = min-links
  IF energize > m → energize = m
```

### In the Above Example:

“ΣBp( )” is a peak bandwidth summation across a set of Hashes during some periodic evaluation interval. The summation itself must be short enough to meaningful to the Queue depth;

“Bt( )” is a parameter determined based on whether one or more Hashes have non-link-local traffic (e.g. LACPDU) during the de-energization evaluation interval. This value is either a true or a false

“m” refers to the number of members of the EtherChannel (including unenergized);

“DT” is a De-energization Threshold for an EtherChannel member port; this is the data rate below which the bandwidth must drop before the algorithm decides to power down a member link; and

∨ is a disjunctive “or” operator; ∧ is a conjunctive “and” operator.

The process may be described as evaluating peak bandwidth in use (Bp) according to selected links of respective hash values, taking priority into account. In some embodiments, the decision of whether to add or subtract a certain link to or from a bundle may include evaluating the peak bandwidth (Bp) for higher priority links that are already energized. Secondary considerations may also group lower priority links for a peak bandwidth analysis.

Referring now to FIG. 6B, at step/operation 612, an actor network device signals for the partner network device to de-energize at least one port. In some examples, the actor network device is configured to periodically run the de-energize algorithm (e.g., every 10 minutes). In some embodiments, <energize>=larger of local and remote <energize> results. The actor network device may include in the next LACPDU on Actor port priority 0, i.e., the highest priority link, the new value for <energize>, which indicates the number of links that should be energized on the bundle. The methods and systems of this disclosure achieve the updated number of links by re-energizing previously de-energized links (identified by respective hashes). Re-energizing occurs sequentially, beginning with the link that has been de-energized the longest, then the next longest, etc. Additionally, if the value <energize> becomes lower, the actor network device may immediately update or run a hash algorithm to steer new traffic away from any physical links or member(s) as necessary. For example, the links in a bundle may be identified with a sequential link number, according to a priority and hash value. Some of the sequential link numbers may be above the value of <energize> (i.e., the sequentially numbered links having identifiers greater than the quantity of links that should be energized for the load). Such a relationship indicates that a link may be de-energized soon. However, if the value <energize> is increased, the actor network device may follow or initiate the “triggered Actor/Partner” logic of FIG. 9 discussed herein.

Returning back to FIG. 6A, at step/operation 604, the partner network device de-energizes port logic. For example, if a LACPDU is received on the physical link with Actor port priority 0 shows a lower number of <energize> than currently energized then the partner network device may update the hash algorithm to steer traffic new away from the physical links/members soon to be de-energized such that new traffic is directed to the new hash. In some examples, the partner network device may wait for most flows to conclude. In some examples, the partner network device sends an LACPDU with a flush command that ensures there is no lingering traffic on a link before powering down the link. This also sets the power down port flag. After the flush concludes, the partner network device powers off one or more ports. In some implementations, if all ports on associated with a line card are shut down, the partner network device powers off the line card. The line card may comprise circuitry providing both transmitting and receiving ports for a local area network (LAN) or wide area network (WAN).

Returning to FIG. 6B, at step/operation 614, the actor network device de-energizes port logic. For example, a network device may receive a LACPDU with power down port flag on, indicating to shut down at least one physical port having a sequential identifier (based on priority and hash values) that is above the quantity of ports that should be energized. The quantity of ports that should be energized is established according to the value of <energize>, and the network device or an associated controller may flush the port to be shut down of any remaining flows and power down local physical port(s). In some implementations, if all ports on associated with a line card are shut down, the actor network device powers off the line card. This is one example of power saving results of this disclosure.

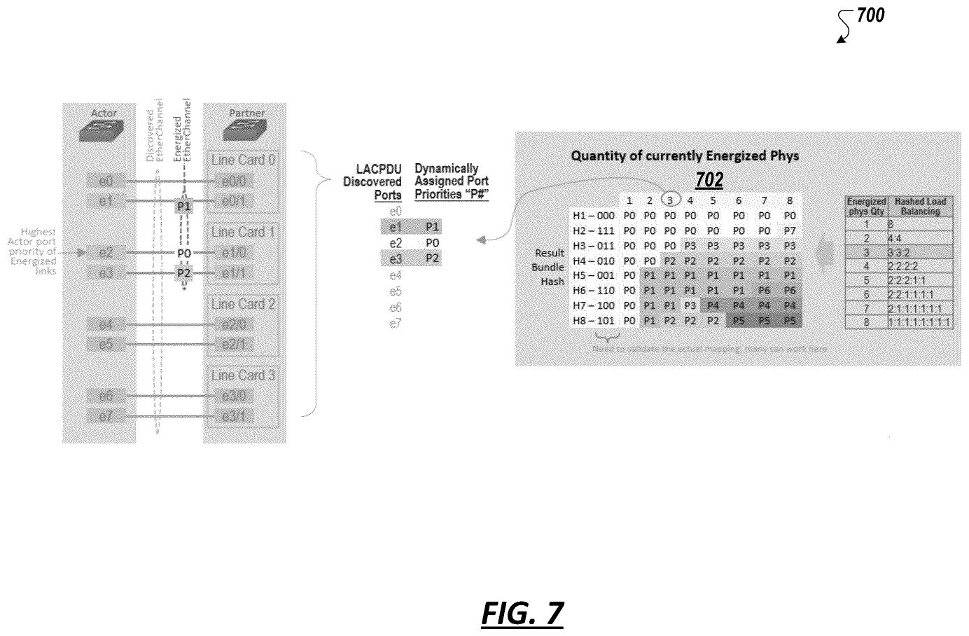

Referring now to FIG. 7, a schematic diagram 700 depicting a physical mapping of a current hash algorithm in accordance with certain embodiments of the present disclosure is provided. A Result Bundle Hash may be a number which is assigned to a flow at ingress to determine which egress port should be used for traffic associated therewith. In the example shown in FIG. 7, within a given data transmission channel (e.g., EtherChannel), each port is assigned a port priority based on the output of a hash algorithm which is shown as a map 702 comprising eight active hash results. As depicted, each of a plurality of LACPDU discovered ports, e1, e2, and e3 is assigned a port priority. In particular, e1 is assigned a priority P1, e2 is assigned a priority P0, and e3 is assigned a priority P2. In the example provided, a lower priority value indicates a higher priority. In some implementations, adaptive load distribution may be utilized to minimize flow migration between physical links or members when hashes change.

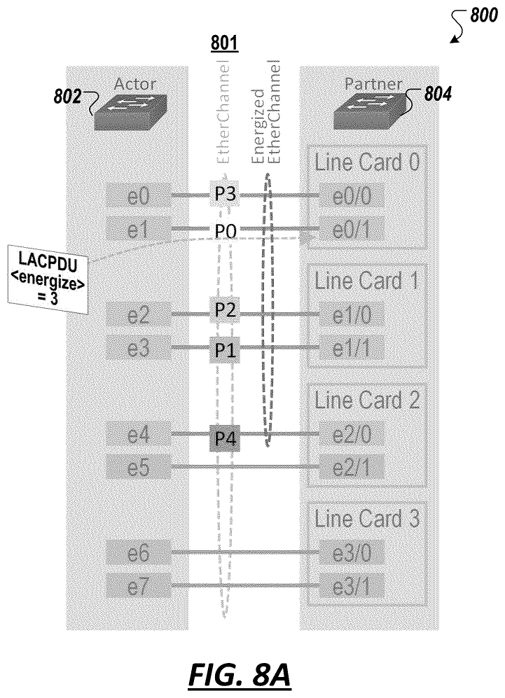

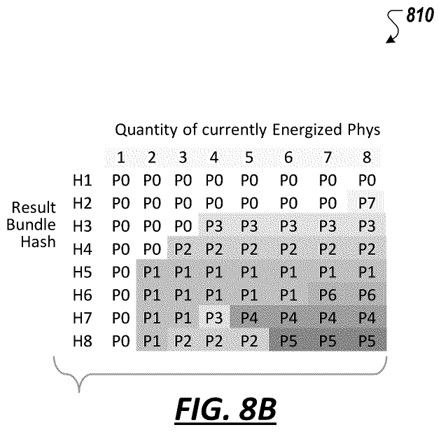

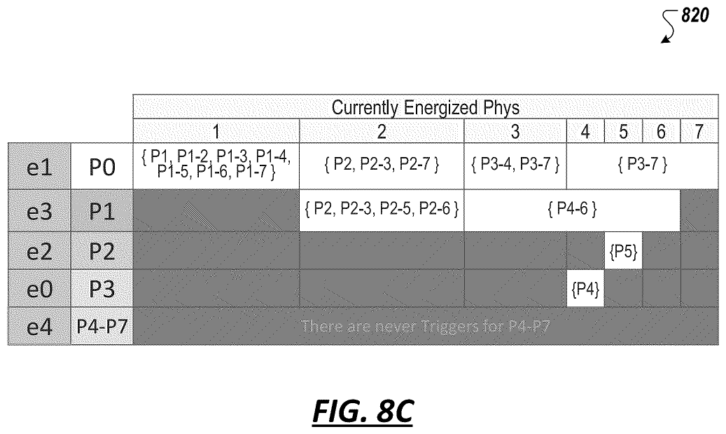

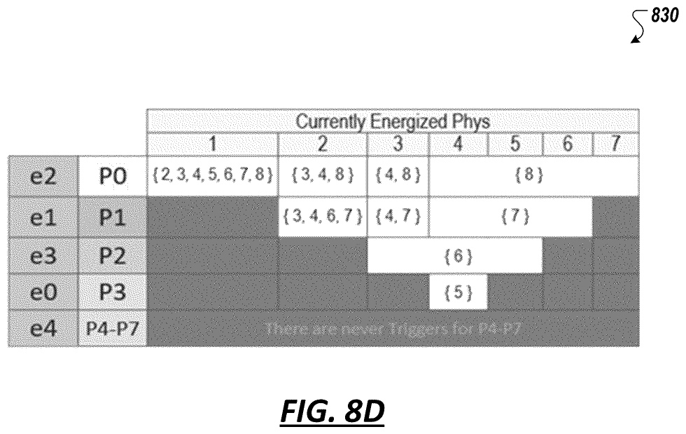

Referring now to FIG. 8A, FIG. 8B, and FIG. 8C, schematic diagrams 800, 810, and 820 depicting aspects of an exemplary context for energizing physical links using an energize algorithm as shown in FIG. 9 are provided.

As depicted in FIG. 8A, a first network device 802 (e.g., actor) and a second network device 804 (e.g., partner) are in electronic communication with one another via a data transmission channel 801 (e.g., EtherChannel). As noted above, at least one network device may be configured to determine a bandwidth queue fill per hash or percent queue fill per hash, which may be obtained (e.g., collected) by a counter on an egress port of the at least one network device. For example, multiple hashes might point to a specific physical link no matter how many available links are available. Accordingly, in such examples, adding additional links does not improve data transmission efficiency because all of the bandwidth being consumed is going to a single hash. For example, if two host computers are trying to communicate at 1 GB/s, and there are five 1GBs EtherChannel links therebetween, only one of those links will be used. In the energize algorithm of FIG. 9, some implementations may use this queue fill count to calculate a peak bandwidth in use summation across a set of hashes during some periodic evaluation interval.

An output of an exemplary hash algorithm is depicted in FIG. 8B, in which a Result Bundle Hash is used to determine which egress port should be used for traffic associated with each of a plurality of ports. Each port in a data transmission channel (e.g., EtherChannel) may be assigned a port priority based on the output of a hash algorithm which is depicted as a map 810 comprising eight active hash results.

Referring now to FIG. 8C, an example table 820 depicting a mapping of a plurality of links in accordance with the protocol illustrated in FIG. 8B is provided. As shown, each active link (e0, e1, e2, e3, and e4) is assigned a port priority. As illustrated, overloading a first physical link, e1, may trigger energization of at least one port and, ultimately, assignment of new port priorities. It should be understood that a certain port may only be configured to offload traffic to new ports when additional bandwidth is required. In some embodiments, when energizing new physical links, link(s) that have been idle for longer time periods may be energized first.

FIG. 8D provides another example table 830 describing a mapping of physical links subject to energization and de-energization protocols in accordance with the present disclosure. An energize algorithm, shown in the non-limiting example of FIG. 9, may be used to calculate how many new links should be energized, and then previously de-energized links can be powered on in order of the time that the new links have been powered off.

Referring now to FIG. 9, a schematic diagram 900 depicting an example implementation of an energize algorithm that includes example computer program code is provided. In some embodiments, all algorithms can be run across the appropriate “currently energized phys” illustrated in FIG. 9. In some examples, a network device may set <energize> to be a maximum value based on the evaluation and may send an LACP energize for the LACPDU to be energized if the value has changed.

Without limiting the computer program code that can be used for any energize or de-energize algorithm, the example of FIG. 9 is used to determine the <energize> value for a bundle of physical ports at any moment in time. The <energize> value may increase, decrease, or stay the same in various implementations, depending on how the traffic demand fluctuates across currently energized links. As shown the computer program code, decisions of whether to update the value of <energize>, depends upon comparing certain variables listed below according to their respective hash values (which inherently incorporates a respective link priority). Generally, traffic on certain links having data rates and therefore peak bandwidth use above a re-energize threshold “RT” can be used to drive new values for the number of links in a bundle that should be energized. Once that value is determined, the matrix of FIG. 8D can be used to select the sequence of energization starting with links that have been de-energized the longest. As shown in FIG. 8D, there may be one or multiple links to choose from for re-energizing. In one non-limiting description of FIG. 9, the variables at issue are as follows:

“RT” is a Re-energization Threshold for an EtherChannel member port;

“ΣBp( )” is a peak bandwidth summation across a set of Hashes during some periodic evaluation interval. The summation itself must be short enough to meaningful to the Queue depth;

“Bt( )” is a parameter determined based on whether one or more Hashes have non-link-local traffic (e.g. LACPDU) during the de-energization evaluation interval. This value is either a true or a false to indicate the presence of traffic that should not be immediately flushed.

“m” refers to the number of members of the EtherChannel (including unenergized).

V is a disjunctive “or” operator; A is a conjunctive “and” operator. The process may be described as evaluating peak bandwidth in use (Bp) according to selected links of respective hash values, taking priority into account. In some embodiments, the decision of whether to add or subtract a certain link to or from a bundle may include evaluating the peak bandwidth (Bp) for higher priority links that are already energized. Secondary considerations may also group lower priority links for a peak bandwidth analysis.

In one non-limiting embodiment, FIG. 9 can be considered pseudocode allowing a network device processor (e.g., a router with computer hardware) or a separate controller the flexibility to gauge, at any point in time, how many links are currently activated (1-7 in FIG. 9), the peak bandwidth in use on links of designated hash values and priority values, and whether the links have other traffic, Bt, that should be accounted for in determining whether to energize or de-energize new links with a new value for <energize>. In one implementation, the <energize> calculation for each number of active links (m from 1 to 7) may be calculated for the links having respective priority values P0 to P3 in this example. Then for each value of m, the highest value of <energize> over all of the priority choices is selected to be sent to the partner device. In other words, one computerized implementation of FIG. 9 sets <energize> to be the maximum from the column evaluations for each quantity “m” of currently energized links, where m=1 through 7. Again, once the new quantity of links to energize has been tabulated as shown in FIG. 8D, the system and method of this disclosure activate individual links in order of longest de-energized to most recently de-energized. Some network devices include software for administrative or manual changes to processes described for de-energization and re-energization. In some embodiments, determining whether or not to energize new physical links may include determining an activation time for at least one new physical link, such as by performing recognize, flush, and/or flow redistribution operations. In some embodiments, determining whether or not to de-energize physical links may include determining whether one or more parameters are satisfied. For example, determining whether a current load is below a predetermined threshold value or percentage, determining whether packet loss threshold value is not exceeded within a predetermined time period, and/or determining that there have been no increase events with a predetermined time period (e.g., 20 minutes).

In some implementations of this disclosure, a bandwidth calculation is driven by specific loads on selected physical links rather than aggregate physical load on the whole bundle of links. The selected links may be grouped according to priority of the link. Accordingly, bandwidth increases/decreases target a consistent ordering of physical links across two network devices coordinated by LACP.

During the turn-down process of a lightly used physical link, redirecting the existing flows to an alternate physical link occurs when it is clear that a previous flow is undergoing a pause which effectively completes (flushes) network queued traffic flowing towards the destination. This feature allows the system to locally tune with a pre-emptive mechanism that understands which specific flow is going next, and gracefully redirect it the new physical port, as noted above.

When traffic is increasing beyond a threshold on a physical link, it might not be necessary to add a new physical link if adding that link would result in the new link being unable to accept any greater number of hash values due to its set up as shown in the inset of FIG. 7 for hashed load balancing. This table on the right of FIG. 7 lists the number/quantity of values of a given priority, which the hash algorithm calculates, that a particular port accepts. So if the system tried to move traffic from by changing from 5 ports to 6 ports randomly, the third link in the 5 port bundle (denoted 2,2,2,1,1) is trying to send two hash values (the third consecutive number two) to the third link in a 6 port bundle (denoted 2,2,1,1,1,1). Unfortunately, energizing the sixth port in that example is not helpful because the third link (denoted with a 1) in a 6-port bundle would only be able to take one hash value. If a certain link in a newly energized set up can only take a minimum number of hashes for a given priority level, then re-energizing that link for traffic from a higher priority level will not change the available bandwidth within the bundle. To avoid this problem, it is possible to locally analyze the traffic in physical link five (5) and define a larger hash that splits the current traffic mix. The system could then send some traffic to a newly charged link six (6), or to a lightly loaded existing link such as one through four (1-4). Such mechanisms for dynamically rebalancing hashing algorithms within a flexible domain of EtherChannel physical links are possible. Other areas which might be applicable here include Consistent Hashing with Bounded Loads.

This disclosure also enables directing certain types of flows to specific EtherChannel physical members. This should be done to ensure the longest lasting flows and the flows having the least loss/delay tolerance are aimed at the EtherChannel Physical port which is likely to stay energized even when the other ports are set to dark. This is possible, due in part to a flush mechanism within EtherChannel (LACP & PAgP) to protect from looping frames. The methods and systems disclosed herein can minimize application layer impacts from such a flush by choosing which flow should go to those physical links unlikely to need a flush.

As discussed above, this disclosure includes an ability for an external system (such as a controller) to predict traffic spikes which will go to any particular member of an EtherChannel, and pre-emptively increase the number of channels energized for a particular EtherChannel. This includes an ability to recognize specific external visible signals which will potentially result in a bandwidth spike on the EtherChannel (e.g., people arriving in a location as seen by new radio connections being made to an access point (AP) for a network). Here, upstream EtherChannels could be energized in preparation of traffic, or the AP sees a DNS lookup to certain websites on the internet which means more traffic is imminent. Also, this disclosure includes an ability for the controller to administratively set/tune the optimal load balancing hash algorithms (per platform or per EtherChannel) to minimize flows which might have to be flushed/moved as part of a growing/shrinking of physical bandwidth.

Implementations described above and in relation to FIGS. 1 through 9 may be used with equipment shown in FIG. 10 that implements computerized methods as described herein. In particular, the described equipment, communicate with a computer processor configured to process one or more characteristics and/or profiles of the electrical signals received. By way of example and without limiting this disclosure to any particular hardware or software, FIG. 10 illustrates a block diagram of a system 1000 herein according to one implementation.

The system 1000 may include a computing unit 1225, a system clock 1245, an output module 1250 and communication hardware 1260. In its most basic form, the computing unit 1225 may include a processor 1230 and a system memory 1240. The processor 1230 may be a standard programmable processor that performs arithmetic and logic operations necessary for operation of the sensor system 1200. The processor 1230 may be configured to execute program code encoded in tangible, computer-readable media. For example, the processor 1230 may execute program code stored in the system memory 1240, which may be volatile or non-volatile memory. The system memory 1240 is only one example of tangible, computer-readable media. In one aspect, the computing unit 1225 can be considered an integrated device such as firmware. Other examples of tangible, computer-readable media include floppy disks, CD-ROMs, DVDs, hard drives, flash memory, or any other machine-readable storage media, wherein when the program code is loaded into and executed by a machine, such as the processor 1230 the machine becomes an apparatus for practicing the disclosed subject matter.

Any combination of one or more computer readable medium(s) may be utilized. The computer readable medium may be a computer-readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer-readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the vehicle computer through any type of network, including a local area network (LAN) or a wide area network (WAN), or the connection may be made to an external computer (for example, through the Internet using an Internet Service Provider).

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular implementations only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The implementation was chosen and described in order to best explain the principles of the invention and the practical application, and to enable others of ordinary skill in the art to understand the invention for various implementations with various modifications as are suited to the particular use contemplated.

It will be apparent to those skilled in the art that various modifications and variations can be made to the disclosed systems and methods for locking detected touch location in a force-based haptic multifunction switch panel. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as hard drives, or any other machine-readable storage medium wherein, when the program code is loaded into and executed by a machine, such as a computer as shown in FIG. 10, and the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for controlling traffic in a data transmission channel comprising a plurality of physical links, the method comprising:
monitoring traffic in the data transmission channel;
detecting a traffic change associated with at least one physical link in the data transmission channel;
based at least in part on the traffic change, determining whether to energize or de-energize at least one of the plurality of physical links; and
based at least in part on the determination and using at least one of an energize algorithm and a de-energize algorithm, redirecting a traffic flow between the plurality of physical links while retaining a sequential ordering of data frames between a plurality of network devices.

2. The method of claim 1, further comprising:
subsequent to de-energizing at least one of the plurality of physical links, reducing energy consumption of at least one network device associated with the at least one physical link.

3. The method of claim 1, wherein determining whether to energize or de-energize at least one of the physical links comprises:
determining a minimum bundle size threshold; and
determining whether a number of energized links is above or below the minimum bundle size threshold.

4. The method of claim 1, wherein redirecting the traffic flow comprises identifying at least one physical link to energize or de-energize using a hash algorithm.

5. The method of claim 4, wherein determining whether to energize or de-energize at least one of the plurality of physical links using a hash algorithm comprises determining a bandwidth percentage queue fill per hash, percentage queue fill per hash, or an expected fill for each of the plurality of physical links.

6. The method of claim 1, wherein redirecting the traffic flow comprises utilizing a flush mechanism to ensure that the sequential ordering of data frames is retained.

7. The method of claim 1, further comprising:
predicting an amount of traffic in the data transmission channel at a future time period; and
energizing or de-energizing at least one of the plurality of physical links during the future time period based at least in part on the predicted amount of traffic.

8. The method of claim 7, wherein the predicting the amount of traffic is performed by a controller in electronic communication with the data transmission channel.

9. An apparatus for controlling traffic in a data transmission channel comprising a plurality of physical links, the apparatus comprising:
a processor; and
a machine-readable medium including instructions executable by the processor comprising:
one or more instructions for monitoring traffic in the data transmission channel;
one or more instructions for detecting a traffic change associated with at least one physical link in the data transmission channel;
one or more instructions for, based at least in part on the traffic change, determining whether to energize or de-energize at least one of the plurality of physical links; and
one or more instructions for, based at least in part on the determination and using at least one of an energize algorithm and a de-energize algorithm, redirecting a traffic flow between the plurality of physical links while retaining a sequential ordering of data frames between a plurality of network devices.

10. The apparatus of claim 9, further comprising:
one or more instructions for, subsequent to de-energizing at least one of the plurality of physical links, reducing energy consumption of at least one network device associated with the at least one physical link.

11. The apparatus of claim 9, wherein the one or more instructions for determining whether to energize or de-energize at least one of the plurality of physical links comprises:
one or more instructions for determining a minimum bundle size threshold; and
one or more instructions for determining whether a number of energized links is above or below the minimum bundle size threshold.

12. The apparatus of claim 9, wherein the one or more instructions for redirecting the traffic flow comprises:
one or more instructions for identifying at least one physical link to energize or de-energize using a hash algorithm.

13. The apparatus of claim 12, wherein the one or more instructions for determining whether to energize or de-energize at least one of the plurality of physical links comprises:
one or more instructions for determining a bandwidth queue fill per hash, percentage queue fill per hash, or an expected fill for each of the plurality of physical links.

14. The apparatus of claim 9, wherein redirecting the traffic flow comprises utilizing a flush mechanism to ensure that the sequential ordering of data frames is retained.

15. The apparatus of claim 9, wherein the instructions executable by the processor further comprise:
one or more instructions for predicting an amount of traffic in the data transmission channel at a future time period; and
one or more instructions for energizing or de-energizing the at least one of the plurality of physical links during the future time period based at least in part on the predicted amount of traffic.

16. A system for controlling traffic in a data transmission channel comprising a plurality of physical links, the system comprising:
a network interface in the data transmission channel configured to receive a data stream;
a processor configured to:
monitor the data stream in the data transmission channel;
detect a traffic change associated with at least one physical link in the data transmission channel;
based at least in part on the traffic change, determine whether to energize or de-energize at least one of the plurality of physical links; and
based at least in part on the determination and using at least one of an energize algorithm and a de-energize algorithm, redirect a traffic flow between the plurality of physical links while retaining a sequential ordering of data frames between a plurality of network devices.

17. The system of claim 16, wherein the processor is further configured to:
subsequent to de-energizing at least one of the plurality of physical links, reduce energy consumption of at least one network device associated with the at least one physical link.

18. The system of claim 16, wherein the processor is further configured to determine whether to energize or de-energize at least one of the plurality of physical links by:
determining a minimum bundle size threshold; and
determining whether a number of energized links is above or below the minimum bundle size threshold.

19. The system of claim 16, wherein the processor is further configured to redirect the traffic flow by identifying at least one physical link to energize or de-energize using a hash algorithm to ensure that the sequential ordering of data frames is retained.

20. The system of claim 16, further comprising a controller in electronic communication with the network interface that is configured to:
predict an amount of traffic in the data transmission channel at a future time period; and
trigger energizing or de-energizing of the at least one of the plurality of physical links during the future time period based at least in part on the predicted amount of traffic.
